(19) United States
(12) Patent Application Publication
(10) Pub. No.: US 2026/0210275 A1
(43) Pub. Date: Jul. 23, 2026

(54) SYSTEM FOR REHEAT STEAM TEMPERATURE TURNDOWN CONTROL IN HEAT RECOVERY STEAM GENERATORS

(71) Applicant: GENERAL ELECTRIC TECHNOLOGY GMBH, Baden (CH)

(72) Inventor: Raub Warfield SMITH, Schenectady, NY (US)

(21) Appl. No.: 19/137,145

(22) PCT Filed: Dec. 13, 2022
(86) PCT No.: PCT/US2022/081440

§ 371 Date: Jun. 9, 2025

(51) Int. Cl. F01K 23/10; F01K 7/22; F22B 1/18; F22G 5/04

(52) U.S. Cl. CPC F01K 23/10; F01K 7/22; F22B 1/1815; F22G 5/04

(57) ABSTRACT

A heat recovery steam generator (HRSG) is disclosed. The HRSG includes a high-temperature section including a first reheater coupled in a parallel orientation with at least one high-pressure superheater, the first reheater separated from the at least one superheater by at least one barrier wall; an evaporator coupled downstream from the high-temperature section, the evaporator configured to extract heat from gases exiting the high-temperature section; and a damper system upstream from the evaporator, the damper system configured to divert gas exiting from an outlet of the first reheater and the outlet of the at least one superheater.

### BACKGROUND

The field of the disclosure relates generally to heat recovery steam generators for gas turbine engine exhausts. More particularly, the disclosure relates to systems for effectuating steam temperature turndown control in heat recovery steam generators.

Heat exchangers are used to transfer heat from one medium to another in a variety of industries. A heat recovery steam generator (HRSG) is an example of a heat exchanger, which may be used in combined cycle power plants and similar plants to generate steam and additional power from exhaust gases. An HRSG may use a gas turbine engine exhaust to heat a fluid flowing through heat exchangers in the HRSG, such as for example, to convert water into steam for supply to a steam turbine. In some configurations, the fluid may be steam generated at multiple pressure levels and channeled to any of the high-pressure, intermediate-pressure, and/or low-pressure sections of a steam turbine. HRSG commonly include a water spray attemperator (desuperheater) to reduce the temperature of the high pressure and reheat exit steam by combining the superheated steam with water, such that the steam is cooled as the water evaporates.

Some combined cycle systems are configured with a steam turbine extractor to provide process steam in support of industrial, carbon capture, or district heating systems. These steam extractions are commonly pressure-controlled to maintain the process steam supply pressure across a steam flow or plant load operating range. If the plant load or process steam demand moves outside of the permissible operating range for steam extraction from the turbine there is typically provisioned to draw steam from a high-pressure steam source with subsequent pressure and temperature reduction to suit process requirements. This fallback mode is much less efficient since the process steam is no longer expanding first to do work in a steam turbine. Operation is most efficient when process steam is available from the steam extraction because it has performed work while expanding to the (lower) pressure required for the process. The minimum steam turbine load where process steam extraction is technically feasible is limited because, as load is reduced, the extraction steam temperature gradually increases until the steam turbine components at the extraction point becomes too hot. This occurs due to decreasing pressure ratio for steam expansion across the turbine between a steam inlet (which falls in pressure with flow reduction) and steam extraction (which is controlled to fixed pressure by valves, as required for supply to the process steam user). The ideal location for steam extraction is often downstream of the intermediate pressure (IP) turbine inlet. This leads to a requirement for intermediate-pressure (IP) turbine inlet (reheat) steam temperature turndown control to manage steam temperature leaving the steam turbine extraction. However, reheat steam temperature control with conventional steam temperature control means may be limited. Extending operation with steam extraction active is desired because it is more efficient than shifting process steam supply to a higher pressure and temperature source since such steam no longer has a chance to do work by first expanding through the steam turbine.

Conventional reheat steam temperature control systems with water spray attemperation between reheat sections is limited by the amount of water that can be safely injected and evaporated within the HRSG. It is also inherently inefficient since high level energy is used to evaporate the spray water within the HRSG. A more efficient approach is to utilize cool steam instead of water to depress the temperature of the steam entering the reheater. This approach however is also limited in temperature control authority by how much the exit steam temperature can be reduced.

Therefore, there is a need in the art to improve reheat steam temperature turndown control in heat recovery steam generator systems.

### BRIEF DESCRIPTION

In one embodiment, a heat recovery steam generator is provided. The heat recovery steam generator includes a high-temperature section including a first reheater coupled in a parallel orientation with at least one high-pressure superheater, the first reheater separated from the at least one superheater by at least one barrier wall; an evaporator coupled downstream from the high-temperature section, the evaporator configured to extract heat from gases exiting the high-temperature section; and, a damper system upstream from the evaporator, the damper system configured to divert gas exiting from an outlet of the first reheater and the outlet of the at least one superheater.

In yet another embodiment, a power generation system is provided. The power generation system a gas turbine configured to generate power and expel exhaust gases through an exhaust; and a heat recovery steam generator having a gas inlet in communication with the exhaust of the gas turbine. The heat recovery steam generator includes a high-temperature section including a first reheater coupled in a parallel orientation with at least one high-pressure superheater, the first reheater separated from the at least one superheater by at least one barrier wall; an evaporator coupled downstream from the high-temperature section, the evaporator configured to extract heat from gases exiting the high-temperature section; and, a damper system upstream from the evaporator, the damper system configured to divert gas exiting from an outlet of the first reheater and the outlet of the at least one superheater.

### BRIEF DESCRIPTION OF THE DRAWINGS

FIG. 1 is a schematic diagram of the high temperature elements of an exemplary prior art power generation system;

FIG. 2 is a schematic diagram of an exemplary heat recovery steam generator including a damper system, that improves upon the power generation system shown in FIG. 1;

FIG. 3A is a schematic diagram of the damper system of FIG. 2 in an open state;

FIG. 3B is a schematic diagram of the damper system of FIG. 2 in a closed state;

FIG. 4 is a schematic diagram of an alternative heat recovery steam generator including a damper system; and,

FIG. 5 is a schematic diagram of an alternative heat recovery steam generator including a damper system.

The reference symbols used in the drawings, and their meanings, are listed in summary form in the list of reference symbols. In principle, identical parts are provided with the same reference symbols in the figures.

### DETAILED DESCRIPTION

In the following specification and the claims, reference will be made to a number of terms, which shall be defined to have the following meanings.

As used herein, the singular forms “a,” “an,” and “the” include plural references unless the context clearly dictates otherwise. The terms “comprising,” “including,” and “having” are intended to be inclusive and mean that there may be additional elements other than the listed elements. The terms “optional” or “optionally” means that the subsequently described event or circumstance may or may not occur, and that the description includes instances where the event occurs and instances where it does not.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms, such as “about,” “approximately,” and “substantially,” is not to be limited to the precise value specified. In at least some instances, the approximating language may correspond to the precision of an instrument for measuring the value. Here and throughout the specification and claims, range limitations may be identified. Such ranges may be combined and/or interchanged and include all the sub-ranges contained therein unless context or language indicates otherwise.

Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

Embodiments of the present disclosure are directed to heat recovery steam generator (HRSG) systems which utilize gas to extend control authority and retain efficiency of steam temperature control. The systems described herein include an evaporator, a reheater and a superheater. The system further includes either a damper system or an air diversion system to redirect, reduce, or divert gas flow to the reheater, thus facilitating reducing reheat steam temperature exiting the HRSG.

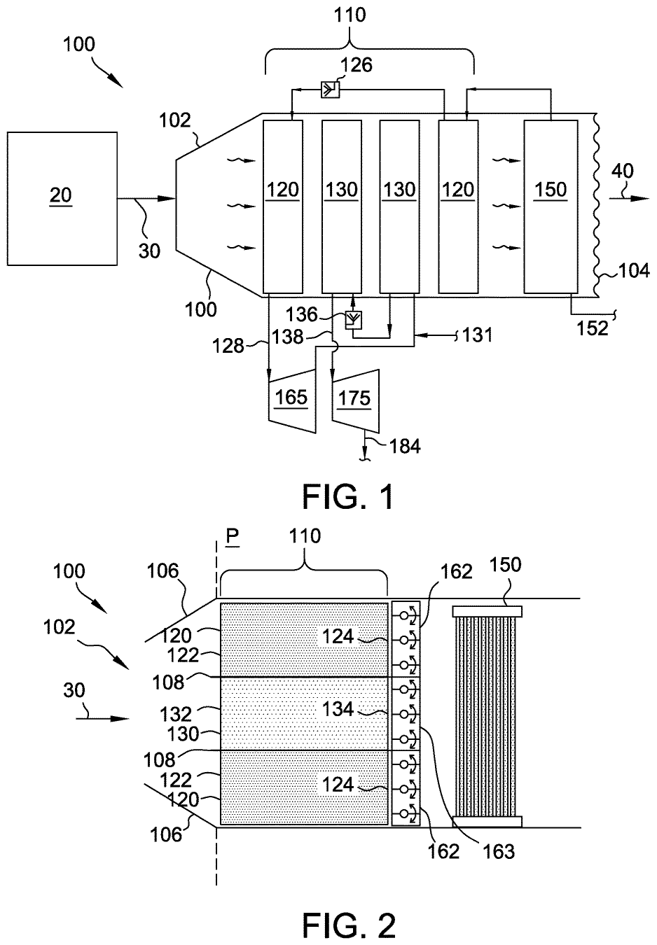

FIG. 1 is a block diagram of the high temperature portion of an exemplary power generation system 10 that includes a gas turbine 20, an HRSG 100, a high-pressure steam turbine 165, and an intermediate temperature steam turbine 175. Note that the elements shown and labeled in the HRSG 100 are only the forward most sections of interest for this disclosure. The HRSG 100 includes an inlet section 102 and an outlet interface 104 that directs warm gas 40 into downstream components of the HRSG 100 comprised of economizers, evaporators, and superheaters for HP, IP, and typically LP steam generation modules (not shown). In some embodiments, the HRSG 100 further includes downstream emissions reduction catalysts (not shown).

The HRSG 100 receives hot exhaust gas 30 from the gas turbine 20, which flows through a high-pressure superheater and reheater section (referred to high-temperature section 110), and an evaporator 150. The HRSG 100 is an indirect heat exchanger in which water or steam is provided to the evaporator 150 of the HRSG 100 to enable heat to be extracted from the hot exhaust gas 30 within the HRSG 100.

The high-temperature section 110 includes configurations of reheaters 130 and high-pressure superheaters 120 typically arranged in series. High pressure (HP) steam generated in evaporator 150 is superheated by the exhaust gas 30 as it passes through the HRSG 100, which cools the exhaust gas 30 as it provides heat to steam. The superheater 120 can include a steam outlet 128 in which HP steam exiting the superheater 120 supplies a HP steam turbine 165 connected to the steam outlet 128 of the superheater 120. The HP steam turbine which expands the steam to an intermediate pressure (IP) for reheating before admission to the IP steam turbine 175. The reheater 130 includes a steam outlet 138 which supplies the IP steam turbine 175. Additional IP steam 131 may be added to the HP turbine exhaust steam exiting the HP steam turbine 165 which enters the reheater 130. The HP steam temperature exiting the steam outlet 128 of the superheater 120 and the IP steam temperature exiting the steam outlet 138 of the reheater 130 are each controlled by injection of water to steam at attemperators (126 or 136) respectively. Steam exiting a steam outlet 184 of the IP turbine 175 proceeds to a low-pressure turbine and/or the process user (not shown).

The evaporator 150 is downstream from the high-temperature section 110 extracts heat from the exhaust gases 30 exiting the high-temperature section 110. The evaporator 150 includes a series of fluid tubes (not shown) that extract heat from the exhaust gases 30 exiting the high-temperature section 110. The fluid tubes of the evaporator 150 are coupled by fluid conduits 152 to a HP feed water system (not shown) and economizing sections (not shown) to a feed water pump system (not shown) that circulates fluid within the system. As the exhaust gases 30 flow through the evaporator 150 and downstream HP economizers, IP and possibly LP steam generation circuits, exhaust gas is further cooled before exhausting to a stack or downstream process such as a carbon capture system (CCS).

FIG. 2 is a schematic diagram of an exemplary embodiment of the high temperature portion of HRSG 100. In the exemplary embodiment, the HRSG 100 includes the high-temperature section 110, and the evaporator 150 downstream from the high-temperature section 110. The HRSG 100 has enclosing walls 106 that define a heating gas duct through which the exhaust gases 30 gas from the gas turbine 20 flow (in the direction indicated by arrow 30).

In the exemplary embodiment, the high-temperature section 110 includes at least two high pressure superheaters 120 coupled in a parallel orientation with at least one reheater 130. Each of the superheaters 120 includes an inlet 122 and an outlet 124, and the reheater 130 includes an inlet 132 and an outlet 134. As used herein, the term “parallel” configuration denotes an arrangement of heat transfer sections in which the superheaters 120 and the reheater 130 are adjacent to one another with respect to gas flow through them, the inlets (122, 132) are upstream from the outlets (124, 134), and the inlets (122, 132) of the superheaters 120 and the reheater 130 are substantially aligned along a plane P. Each of the superheaters 120 and the reheater 130 are separated by barrier walls 108, such that only exhaust gases 30 can enter and exit from the respective inlets (122, 132) and outlets (124, 134) of the superheaters 120 and the reheater 130. The barrier walls 108 separating the superheaters 120 and the reheater 130 are temperature rated and are selected based on the normal/operating gas temperature of the exhaust gases 30 cooled by steam. In some embodiments, the barrier walls 108 are rated for approximately 900 degrees Fahrenheit to approximately 1300 degrees Fahrenheit.

In some embodiments, high-temperature section 110 includes a plurality of high-pressure superheaters 120 and a plurality of reheaters 130 coupled in the parallel configuration such that each reheater 130 is between the plurality of superheaters 120, and the plurality of superheaters 120 are separated by barrier walls 108 from the reheaters 130.

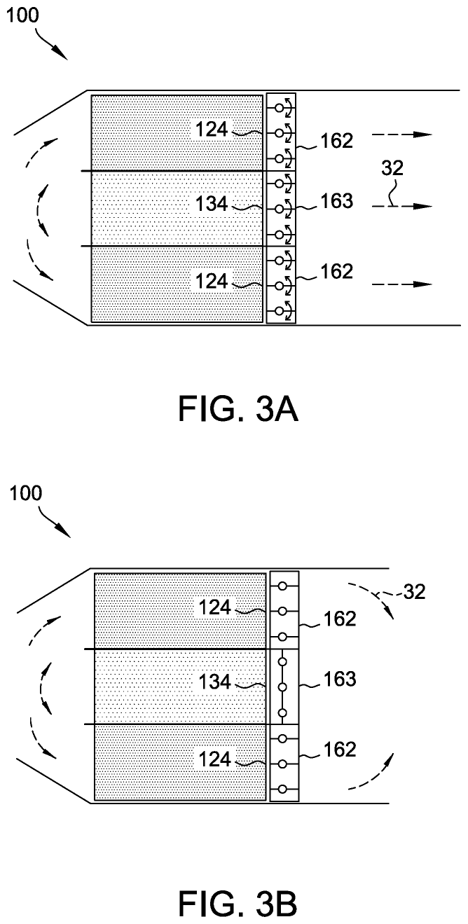

An evaporator 150 is downstream from the high-temperature section 110 to extract additional heat from the exhaust gases 32 (indicated as dashed arrows in FIGS. 3A and 3B) exiting the high-temperature section 110. In some embodiments, the evaporator 150 is a once-through high pressure evaporator through which feed water from the fluid conduits 152 of the HP feed water system (not shown) is channeled therethrough.

In the exemplary embodiment, a damper system 160 is used to control steam temperature. Damper system 160 is downstream from the high-temperature section 110 (the superheaters 120 and the reheater 130) such that gases exiting from the outlets (124, 134) of the superheaters 120 and the reheater 130 are channeled through the damper system 160. As such, in the exemplary embodiment, the damper system 160 is between the high-temperature section 110 and the evaporator 150 to enable exhaust gases exiting the outlets (124, 134) of the superheaters 120 and the reheater 130 to be diverted. Moreover, the damper system 160 enables reheat steam temperature turndown and regulation of the reheat steam temperature exiting from the high-temperature section 110 to facilitate maintaining the steam turbine extraction temperature at the steam outlet 184 within the material limits of components within the power generation system 10 with pressure-controlled steam turbine extraction active.

The damper system 160 includes independently controlled dampers that are selectively movable at the outlets (124, 134) of the superheaters 120 and the reheater 130. Stated differently, the superheaters 120 are upstream from the superheater dampers 162, and the reheater 130 is upstream from a reheater damper 163. The dampers (162, 163) can be independently and selectively moved to a fully opened position/state (shown in FIG. 3A), a fully closed position/state (shown in FIG. 3B) or positioned in an intermediate state between the fully opened and closed positions (referred to hereinafter as “partially open position”). Modulation of reheater damper 163 between the fully open position and the fully closed position provides closed loop temperature control of reheat steam entering the IP steam turbine 175 across a very large operating range since in the fully closed position, no gas flows through the reheater 130 as shown in FIG. 3B. In similar fashion HP steam temperature can be controlled via modulation of a portion of superheater damper 162 and/or coordinated with additional HP steam temperature control provisions (not shown).

By way of example, in FIG. 3A, all of the dampers (162, 163) are in the fully opened position, and gas (illustrated by vectors showing airflow pattern) flows uninterrupted through the superheaters 120 and the reheater 130. In some embodiments, the dampers (162, 163) are louvers. In other embodiments, the dampers (162, 163) are flap diverters. In other embodiments, the dampers (162, 163) are diverter dampers. In some embodiments, the dampers (162, 163) are tandem diverters. In some embodiments, the dampers (162, 163) are butterfly dampers. In alternative embodiments, any other type of damper that enables damper system 160 to function as described herein may be used.

As shown in FIG. 3B, the reheater damper 163 is in the fully closed position while the superheater dampers 162 are in the fully open position. In such a configuration, the reheater damper 163 diverts gas (illustrated by vectors showing airflow pattern) toward the superheaters 120. In some embodiments, the reheater damper 163 is moved to the partially open position while the superheater dampers 162 are in the fully open position, thus creating a gas side pressure differential between the reheater 130 and superheaters 120 and reducing gas flow to the reheater 130. Such a pressure differential results in increasing the velocity of the gases directed to the superheaters 120 as the gases are diverted from the reheater 130. This facilitates improving heat transfer in the superheaters 120. In some embodiments, the damper system 160 includes only the reheater damper 163.

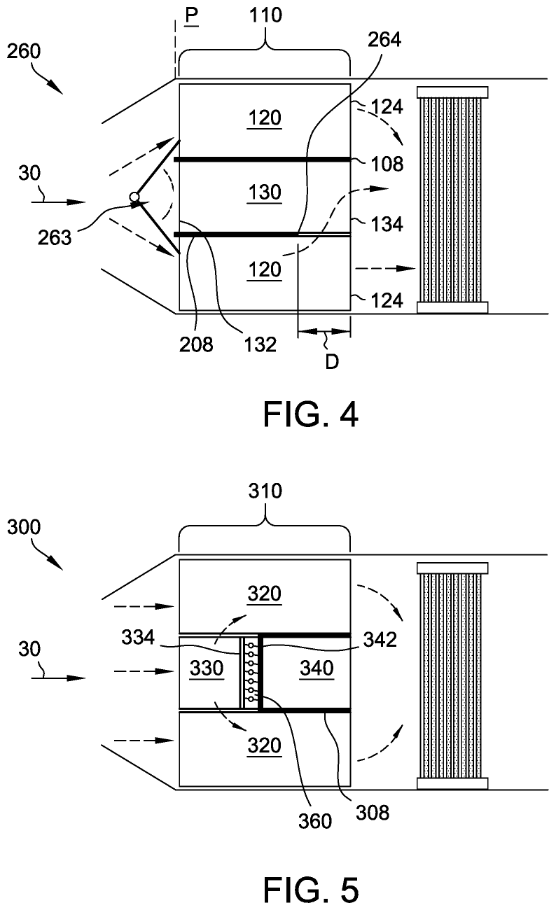

FIG. 4 illustrates an alternative embodiment damper system 260 of damper system 160 (shown in FIG. 2). In the exemplary embodiment of FIG. 4, the damper system 260 includes a single reheater damper 263 upstream from the inlet 132 of the reheater 130. The reheater damper 263 can be moved to a fully opened position, to a fully closed position, or to any intermediate position between the fully opened and fully closed positions (referred to hereinafter as “partially open position”). Similar to the damper system 160 of FIG. 2, the reheater damper 263 selectively reduces exhaust flow to the reheater 130, and the reheater damper 263 diverts gases (illustrated by vectors showing gas pattern) towards the superheaters 120 by selectively moving the reheater damper 263 to one of the fully opened, fully closed, or partially opened positions.

In some embodiments, the barrier walls 108 separating the reheater 130 from the superheaters 120 can be porous such that gases can partially enter the reheater 130. In some embodiments, one or both of the barrier walls 108 include are formed with a gap (not shown) that enables partial entry of gases into the reheater 130. The gap may extend along the full length of the one or both of the barrier walls 108 or may only extend partially along the length of the barrier wall 108 towards the outlets (124, 134) of the reheater 130 and superheaters 120. Partial or porous barrier walls 108 allow the maximum authority of the reheat steam temperature control to be limited and also to reduce smooth out the gas temperature profile entering the downstream evaporator 150. By way of example, an end 264 of one of the barrier walls 208 is a distance D from the outlets (124, 134) such that gases are partially diverted from the superheater 120 adjacent to the barrier wall 208. The barrier wall 208 is fabricated from a material selected to be temperature rated for, and withstand, isothermal temperature differentials. The damper system 260 enables reheat steam temperature turndown and regulation of the reheat steam temperature to maintain steam turbine extraction temperature within material limits of components of the power generation system 10 with pressure-controlled steam turbine extraction active.

FIG. 5 illustrates a schematic diagram of an alternative embodiment of the HRSG 100 and the damper system 160 (shown in FIG. 2). In the exemplary embodiment of FIG. 5, the HRSG 300 includes high-temperature section 310 having a first reheater 330 and a second reheater 340 in a series configuration, and superheaters 320 arranged in a parallel configuration with the first reheater 330 and second reheater 340, similar to those shown in FIG. 1. As used herein, the term series configuration denotes an arrangement of reheaters (330, 340) where an outlet 334 of the first reheater 330 is in-line with, and upstream from, an inlet 342 of an adjacent second reheater 340.

The first reheater 330 and second reheater 340 are separated by an in-line damper 360 to facilitate control of gas flow between the first reheater 330 and the second reheater 340. In the exemplary embodiment, the damper 360 may be, but is not limited to only being, a louver, a flap diverter, and/or a butterfly damper. Alternatively, any other type of damper that enables damper system to function as described herein may be used. Similar to the damper system 260 (shown in FIG. 4), the damper 360 can be selectively moved to a fully opened position, a fully closed position, or to any intermediate position between the fully opened and fully closed positions (referred to hereinafter as “partially open position”). The damper 360 selectively reduces gas flow between the first reheater 330 and the second reheater 340 and diverts gases (illustrated by vectors showing airflow pattern) toward the superheaters 320 due to a pressure differential between the second reheater 340 and the superheaters 320 arranged in parallel. The barrier wall 308 separating the superheaters 320 and the second reheater 340 are temperature rated and are selected based on maximum temperature of the exhaust gas 30 cooled by steam seen at the damper 360 location. The damper 360 enables reheat steam temperature turndown and regulation exiting the high-temperature section 310 to facilitate maintaining the steam turbine extraction temperature within the material limits of components within the power generation system 10 with pressure-controlled steam turbine extraction active.

The systems described herein facilitate reducing or diverting gas flow to the reheater or directly controlling the gas temperature entering the reheater, thus resulting in a controlled reheat steam temperature exiting from the high-temperature section of the HRSG. In particular, the damper systems regulate hotter and cooler gases exiting the high-temperature section such that the evaporator receives gases of the nearly the same average temperature while controlling steam temperature out of the reheater. Furthermore, the damper system facilitates enhancing operational flexibility and control of superheater and reheater loading, by diverting gas through selectively opened and closed dampers, without having to rely on an attemperator to mix spray water or steam midway through the reheater and superheater. Neither spray water nor steam mixing for steam temperature control have the necessary control authority to substantially extend steam extraction to process operation to low loads with pressure-controlled steam turbine extraction active.

The methods, systems, and compositions disclosed herein are not limited to the specific embodiments described herein, but rather, steps of the methods, elements of the systems, and/or elements of the compositions may be utilized independently and separately from other steps and/or elements described herein. For example, the methods, systems, and compositions are not limited to practice with only a rotary machine as described herein. Rather, the methods, systems, and compositions may be implemented and utilized in connection with many other applications.

Although specific features of various embodiments may be shown in some drawings and not in others, this is for convenience only. Moreover, references to “one embodiment” in the above description are not intended to be interpreted as excluding the existence of additional embodiments that also incorporate the recited features. In accordance with the principles of the disclosure, any feature of a drawing may be referenced and/or claimed in combination with any feature of any other drawing.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the invention has been described in terms of various specific embodiments, those skilled in the art will recognize that the invention can be practiced with modification within the spirit and scope of the claims.

Further aspects of the invention are provided by the subject matter of the following clauses:

A heat recovery steam generator comprising: a high-temperature section including a first reheater coupled in a parallel orientation with at least one high-pressure superheater, the first reheater separated from the at least one superheater by at least one barrier wall; an evaporator coupled downstream from the high-temperature section, the evaporator configured to extract heat from gases exiting the high-temperature section; and, a damper system upstream from the evaporator, the damper system configured to divert gas exiting from an outlet of the first reheater and the outlet of the at least one superheater.

The heat recovery steam generator in accordance with any of the preceding clauses, wherein the damper system includes a superheater damper coupled at an outlet of the at least one superheater and a reheater damper coupled at an outlet of the first reheater.

The heat recovery steam generator in accordance with any of the preceding clauses, wherein the superheater damper and the reheater damper are each selectively movable from a fully opened position to a closed position, and to any position between the fully opened and fully closed positions.

The heat recovery steam generator in accordance with any of the preceding clauses, wherein when moved to fully opened position, gas flows uninterrupted through the at least one superheater and the first reheater.

The heat recovery steam generator in accordance with any of the preceding clauses, wherein placing the reheater damper in the closed position causes exhaust gases to be diverted towards toward the superheaters.

The heat recovery steam generator in accordance with any of the preceding clauses, wherein placing the reheater damper in a partially opened position creates a pressure differential between the first reheater and the at least one superheater such that gas flow through the first reheater is reduced.

The heat recovery steam generator in accordance with any of the preceding clauses, wherein the reheater damper and the superheater damper are each at least one of a louver, a flap diverter damper, a tandem damper, and a butterfly damper.

The heat recovery steam generator in accordance with any of the preceding clauses, wherein the damper system includes a reheater damper coupled at an inlet of the first reheater, the reheater damper selectively movable from a fully opened position to a fully closed position, and to any intermediate position between the fully opened and fully closed positions.

The heat recovery steam generator in accordance with any of the preceding clauses, wherein the reheater damper selectively reduces a gas flow to the first reheater, and the reheater damper selectively diverts exhaust gases towards the at least one superheater by selectively moving the reheater damper to any position from the fully opened position to the fully closed position.

The heat recovery steam generator in accordance with any of the preceding clauses, wherein the at least one barrier wall is positioned between the first reheater and the at least one superheater is porous such that gases can partially enter the first reheater from the at least one superheater.

The heat recovery steam generator in accordance with any of the preceding clauses, wherein the at least one barrier wall is positioned between the first reheater and the at least one superheater includes an opening such that gases can partially enter the first reheater from the at least one superheater.

The heat recovery steam generator in accordance with any of the preceding clauses, wherein the at least one barrier wall is positioned between the first reheater and the at least one superheater extends to a distance from the outlet of the first reheater such that gases can partially enter the first reheater from the at least one superheater.

The heat recovery steam generator in accordance with any of the preceding clauses, wherein the high-temperature section includes a second reheater in series orientation with the first reheater and barrier walls between the second reheater and adjacent superheater(s)

The heat recovery steam generator in accordance with any of the preceding clauses, wherein the first reheater and second reheater are separated by an in-line damper positioned to control a gas flow between the first reheater and the second reheater.

The heat recovery steam generator in accordance with any of the preceding clauses, wherein the in-line damper selectively reduces gas flow to the second reheater, and the in-line damper selectively diverts exhaust gases toward the at least one superheater such that, the in-line damper in the partially closed position creates a pressure differential between the at least one superheater and the second reheater in in parallel arrangement.

The heat recovery steam generator in accordance with any of the preceding clauses, wherein the in-line damper is at least one of a louver, a flap diverter, a tandem damper, and a butterfly damper.

A power generation system comprising: a gas turbine configured to generate power, and expel exhaust gases through an exhaust; and, a heat recovery steam generator having a gas inlet in communication with the exhaust of the gas turbine: a high-temperature section including a first reheater coupled in a parallel orientation with at least one high-pressure superheater, the first reheater separated from the at least one superheater by at least one barrier wall; an evaporator coupled downstream from the high-temperature section, the evaporator configured to extract heat from gases exiting the high-temperature section; and, a damper system upstream from the evaporator, the damper system configured to divert gas exiting from an outlet of the first reheater and the outlet of the at least one superheater.

The power generation system in accordance with any of the preceding clauses, wherein the damper system includes a reheater damper coupled at an inlet of the first reheater, the reheater damper selectively movable from a fully opened position to a fully closed position, and to any intermediate position between the fully opened and fully closed positions.

The power generation system in accordance with any of the preceding clauses, wherein the high-temperature section includes a second reheater in series orientation with the first reheater, wherein the first reheater and second reheater are separated an in-line damper positioned to control airflow between the first reheater and the second reheater.

What is claimed is:

1. A heat recovery steam generator comprising:
a high-temperature section including a first reheater coupled in a parallel orientation with at least one high-pressure superheater, the first reheater separated from the at least one superheater by at least one barrier wall;
an evaporator coupled downstream from the high-temperature section, the evaporator configured to extract heat from gases exiting the high-temperature section; and,
a damper system upstream from the evaporator, the damper system configured to divert gas exiting from an outlet of the first reheater and the outlet of the at least one superheater.

2. The heat recovery steam generator of claim 1, wherein the damper system includes a superheater damper coupled at an outlet of the at least one superheater and a reheater damper coupled at an outlet of the first reheater.

3. The heat recovery steam generator of claim 2, wherein the superheater damper and the reheater damper are each selectively movable from a fully opened position to a closed position, and to any position between the fully opened and fully closed positions.

4. The heat recovery steam generator of claim 3, wherein when moved to fully opened position, gas flows uninterrupted through the at least one superheater and the first reheater.

5. The heat recovery steam generator of claim 3, wherein placing the reheater damper in the closed position causes exhaust gases to be diverted towards toward the at least one superheater.

6. The heat recovery steam generator of claim 3, wherein placing the reheater damper in a partially opened position creates a pressure differential between the first reheater and the at least one superheater such that gas flow through the first reheater is reduced.

7. The heat recovery steam generator of claim 2, wherein the reheater damper and the superheater damper are each at least one of a louver, a flap diverter damper, a tandem damper, and a butterfly damper.

8. The heat recovery steam generator of claim 1, wherein the damper system includes a reheater damper coupled at an inlet of the first reheater, the reheater damper selectively movable from a fully opened position to a fully closed position, and to any intermediate position between the fully opened and fully closed positions.

9. The heat recovery steam generator of claim 8, wherein the reheater damper selectively reduces gas flow to the first reheater, and the reheater damper selectively diverts exhaust gases towards the at least one superheater by selectively moving the reheater damper to any position from the fully opened position to the fully closed position.

10. The heat recovery steam generator of claim 8, wherein the at least one barrier wall is positioned between the first reheater and the at least one superheater is porous such that gases can partially enter the first reheater from the at least one superheater.

11. The heat recovery steam generator of claim 8, wherein the at least one barrier wall is positioned between the first reheater and the at least one superheater includes an opening such that gases can partially enter the first reheater from the at least one superheater.

12. The heat recovery steam generator of claim 8, wherein the at least one barrier wall is positioned between the first reheater and the at least one superheater extends to a distance from the outlet of the first reheater such that gases can partially enter the first reheater from the at least one superheater.

13. The heat recovery steam generator of claim 1, wherein the high-temperature section includes a second reheater in series orientation with the first reheater.

14. The heat recovery steam generator of claim 13, wherein the first reheater and second reheater are separated by an in-line damper positioned to control gas flow between the first reheater and the second reheater.

15. The heat recovery steam generator of claim 14, wherein the in-line damper selectively reduces gas flow to the second reheater, and the in-line damper selectively diverts exhaust gases toward the at least one superheater such that, the in-line damper in the partially closed position creates a pressure differential between the at least one superheater and the second reheater in in parallel arrangement.

16. The heat recovery steam generator of claim 14, wherein the in-line damper is at least one of a louver, a flap diverter, a tandem damper, and a butterfly damper.

17. A power generation system comprising:
a gas turbine configured to generate power, and expel exhaust gases through an exhaust; and,
a heat recovery steam generator having a gas inlet in communication with the exhaust of the gas turbine, the heat recovery steam generator comprising:
a high-temperature section including a first reheater coupled in a parallel orientation with at least one high-pressure superheater, the first reheater separated from the at least one superheater by at least one barrier wall;
an evaporator coupled downstream from the high-temperature section, the evaporator configured to extract heat from gases exiting the high-temperature section; and,
a damper system upstream from the evaporator, the damper system configured to divert gas exiting from an outlet of the first reheater and the outlet of the at least one superheater.

18. The power generation system of claim 17, wherein the damper system includes a reheater damper coupled at an inlet of the first reheater, the reheater damper selectively movable from a fully opened position to a fully closed position, and to any intermediate position between the fully opened and fully closed positions.

19. The power generation system of claim 17, wherein the high-temperature section includes a second reheater in series orientation with the first reheater, wherein the first reheater and second reheater are separated by an in-line damper positioned to control airflow between the first reheater and the second reheater.
